(19) United States
(12) Patent Application Publication
(10) Pub. No.: US 2004/0050205 A1
(43) Pub. Date: Mar. 18, 2004

(54) Hand grip device

(76) Inventor: Andrew M Putnam, Hendersonville, TN (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/398,674

(22) PCT Filed: Oct. 9, 2001
(86) PCT No.: PCT/US01/31384

(51) Int. Cl. B62K 21/26

(52) U.S. Cl. 74/558

(57) ABSTRACT

Hand grip apparatus (100) that wraps around an object to be gripped is described, including a multi-layered flexible gripping surface (102) dimensioned to wrap around the object. The multi-layered flexible gripping surface includes a cover layer (112) of an elastomeric material, a base layer (116) of a rubberized material, and a gel layer (126) interposed between the cover layer and the base layer. In use on the object, the gripping surface is secured in place by fastening elements (120, 122) that are secured to the flexible gripping surface and configured to cooperatively engage when the grip apparatus is wrapped around the object.

### CROSS-REFERENCE TO RELATED APPLICATIONS

This application is the national stage of international application PCT/US01/31384 and claims priority to Provisional Applications 60/238,927 filed on Oct. 10, 2000 and Provisional Application 60/240,257 filed on Oct. 13, 2000, both of which are incorporated herein by reference.

### TECHNICAL FIELD

The invention relates generally to hand grips and, more specifically, to a novel grip apparatus for vehicle steering wheels and handlebars.

### BACKGROUND ART

It has long been recognized that the act of gripping the steering wheel of a motor vehicle can be uncomfortable for vehicle operators under certain conditions. For example, during extended periods of driving the driver is susceptible to fatigue resulting from maintaining a constant firm grip on the steering wheel. In addition, stress caused by daily activities of work and commuting can also result in physical discomfort while gripping a steering wheel. Certain steering wheel configurations, such as those having molded indentations, permit certain hand positions that allow for a grip that has less likelihood of the driver's hand slipping on the wheel. In other cases, during periods of exposure to direct sunlight, such as in an open parking lot, steering wheels made of hard plastic compositions can become so extremely hot to the touch that gripping the wheel becomes uncomfortable. Also, during travel over rough roads or terrain, vibration transmitted through the steering column to the steering wheel can make proper gripping difficult and uncomfortable. Similar problems of hand fatigue and discomfort are encountered with grips on bicycle handlebars and other devices that are gripped by a hand, either repeatedly or for extended periods of time. Typically, steering wheel covers, padded gloves or plastic grips have been used to address these problems.

A typical steering wheel cover consists of a material such as rubberized foam, fabric, leather or vinyl (as imitation leather) of suitable shape and size to cover the steering wheel. Rubberized foam steering wheel covers are typically elasticized and stretch into place over the wheel to be held in place by elasticity. Fabric type covers are typically a short nap terry cloth or imitation fur, with a nonslip lining and elastic hem around the inside edges of the cover to hold the cover in place over the steering wheel. Lace-on leather or vinyl covers are designed to offer a sporty look and feel. Most leather or vinyl covers are secured to the wheel with a tie that wraps around the cover and wheel. Such covers are typically thin and unpadded and are used to conceal a damaged steering wheel or to dress up the car interior. Lace-on vinyl covers are less costly, but leather covers have a generally preferred look and feel.

However, known steering wheel covers are limited in certain respects. In particular, known steering wheel covers of thick fabric or covers with foam padding typically increase the diameter of the steering wheel over the entire circumference of the wheel, marring the appearance of the car interior by making the wheel appear large and awkward. Unneeded padding or fabric around the entire wheel can interfere with normal driving, especially during acute turns. The method of attachment of the cover to the wheel is often unsightly, leaving loose or frayed lacing ends or exposed elasticized hems. Fabric covers can quickly become dirty and unsightly, while leather, vinyl and rubberized foam covers can be especially uncomfortable to grip in the heat. In addition, unpadded steering wheel covers do not offer any sort of grip relief, stress relief or opportunity to exercise the hand. Further, mass-produced steering wheel covers are dimensioned to fit standard steering wheels in automobiles, and are not easily adaptable to alternative steering wheel dimensions. Nor are steering covers adaptable to other gripping surfaces that are encountered in other vehicles or equipment such as bars or levers as may be found in construction equipment and machine equipment, (such as in a production facility), paddles for watercraft, exercise equipment and sporting goods, and physical rehabilitation devices.

In the exercise and fitness field, hand exercisers are available and generally include devices consisting of a pair of hand grips coupled to a spring between them, and compression devices such as balls or cylinders of rubber or other compressible material. Other devices generally available as “stress relief” aids include pillow-like devices consisting of a plastic, fabric or latex balloon filled with a nonperishable seed, grain, or putty that is malleable, spongy foam devices in various shapes and sizes, and soft, squeezable rubber balls. However, such devices are not intended or constructed for use during driving or other tasks that involve long periods of gripping. A known hand exercise device exists and can be positioned on an object such as a steering wheel. The device is an injection-molded resilient body member formed with a bore extending therethrough, and with finger depressions molded along one side of the body member for receiving fingers gripping the device. However, because the device is injection-molded and formed with molded finger depressions, the device is limited in its ability to conform to varying shapes, diameters and configurations of steering wheels, as well as it's ability to be readily adapted to other uses of hand gripped applications other than steering wheels such as a rectangular lever, and to varying hand sizes and hand positions. The pre-molded finger depressions are especially a problem for long trips during which a driver typically desires to vary grip position on the device.

Thus, a need remains for a hand grip that is suitable for positioning on a steering wheels or handle bar of a vehicle, that also provides stress relief, exercise and increased comfort for the vehicle operator or driver. A need also remains for such a hand grip that conforms to varying steering wheel shapes and configurations, as well as to varying hand sizes and hand positions on the grip. A need also remains for a hand grip that is adaptable for use with other objects to be gripped, such as handlebars, paddles and oars, levers, machine equipment, physical therapy devices and the like. A need also remains for a hand grip that provides various aspects of grip relief while also maintaining an attractive appearance.

### SUMMARY OF THE INVENTION

The hand grip apparatus of the present invention includes a multi-layered flexible gripping surface dimensioned to wrap around an object to be gripped. The multi-layered flexible gripping surface is further dimensioned to provide a first portion that overlaps a second portion of the flexible gripping surface when the flexible gripping surface is wrapped around the object. A first fastening element is secured to the first portion and a second fastening element is secured to the second portion, the second fastening element configured to cooperatively engage the first fastening element to secure the flexible gripping surface in place when disposed on the object to be gripped.

The multi-layered flexible gripping surface includes a cover layer, a base layer and a gel layer interposed between the cover layer and the base layer. The cover layer is fabricated from an elastomeric material, for example a stretch fabric such as a fabric containing spandex. The base layer is fabricated from a stretch material that allows the flexible gripping surface to accommodate variations in size of the object to be gripped, and also provides a non-slip surface to prevent the flexible gripping surface from slipping on the object to be gripped when the flexible gripping surface is disposed in place on the object. Suitable materials for the base layer include, for example, any rubberized material, open- or closed-cell rubber, neoprene, a stretch fabric that is impregnated with a rubberized material, or the like. The gel layer is fabricated from a resiliently compressible gel material, such as a co-polymer gel or silicone gel.

In one embodiment, the gel layer includes at least one cushioning swell projecting from the base layer. In one embodiment, the gel layer includes a finger swell and a palm swell that are sufficiently spaced from one another so that the finger swell provides resilient cushioning beneath the fingers of a gripping hand as it grasps the flexible gripping surface disposed on the object, and so that the palm swell provides resilient cushioning beneath the palm of the gripping hand as it grasps the flexible gripping surface disposed on the object.

In one embodiment, the first fastening element and second fastening element are fabricated from portions of cooperatively engaging hook and loop fastening material. For example, the first fastening element is a loop portion of hook and loop fastening material and the second fastening element is a hook portion of the hook and loop fastening material.

The hand grip is suitable for being wrapped around a gripping area or gripping areas on a steering wheel, handle bars or other objects to be gripped. With the resiliently compressible gel layer, the hand grip also provides stress relief, exercise of the muscles of the fingers, hands, wrist and arms, and increased shock-absorbing comfort for a vehicle operator or driver. For older drivers that may suffer from arthritis or joint pain, the larger grip diameter and squeezable gel areas provide a less painful and more comfortable grip. The multi-layered flexible gripping surface provides the hand grip with the capability of conforming to the varying shapes and configurations of objects to be gripped, as well as to varying hand sizes and hand positions. The hand grip is especially adaptable for use with a variety of objects to be gripped, including the handlebars of motorcycles, bicycles, scooters, mopeds and the like, paddles or oars, trapezes and bars, ski poles, racquets, levers, machines and construction equipment, physical therapy equipment including crutches, canes and walkers, and almost any other kind of handle

### BRIEF DESCRIPTION OF THE DRAWINGS

FIG. 1 is a top plan view of hand grip apparatus in accordance with one embodiment of the present invention;

FIG. 2 is a bottom plan view of the hand grip apparatus shown in FIG. 1;

FIG. 3 is a side cross-sectional view of the hand grip apparatus;

FIG. 4 is a perspective view of a gripping element with the hand grip apparatus disposed thereon;

FIG. 5 is a perspective view of a steering wheel with the hand grip apparatus disposed thereon; and

FIG. 6 is a perspective view of a handle bar with the hand grip apparatus disposed thereon.

### BEST MODE FOR CARRYING OUT THE INVENTION

In general, the hand grip apparatus generally includes a multi-layered flexible gripping surface dimensioned to wrap around, and be secured in place on an object to be gripped, such as a steering wheel or handlebar.

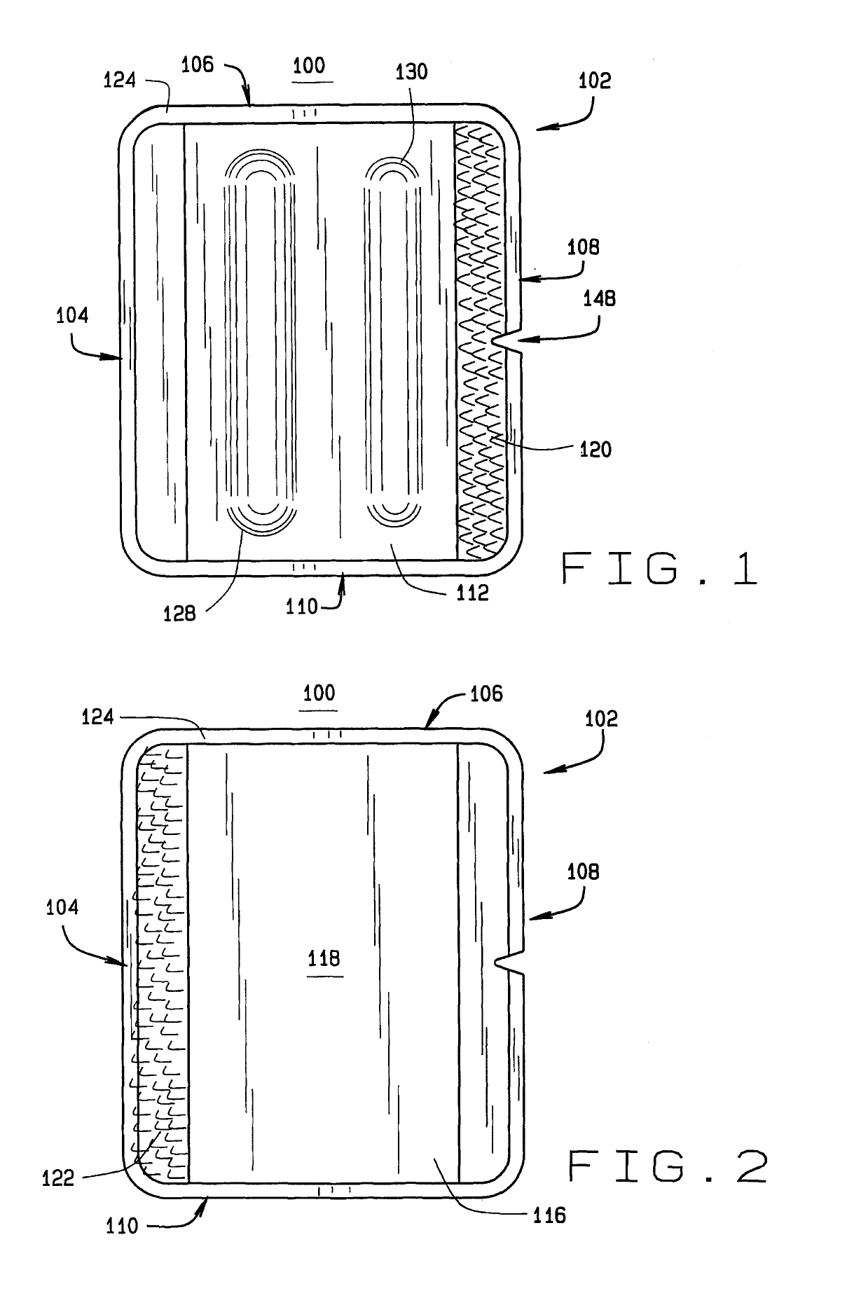

More specifically, FIG. 1 shows a top plan view of the hand grip apparatus 100, and FIG. 2 shows a bottom plan view of hand grip apparatus 100, in accordance with one embodiment of the invention. Hand grip apparatus 100 includes a multi-layered flexible gripping surface 102 having a first edge 104, a second edge 106, a third edge 108, and a fourth edge 110, and having an outer, or cover layer 112 providing an outer surface 114, and an inner, or base layer 116 providing an inner surface 118. Flexible gripping surface 102 is fabricated from sufficiently flexible materials, as described in detail below, such that gripping surface 102 can readily be laid out flat when not in use, for example for display, in storage, or in packaging. Gripping surface 102 is suitably dimensioned to wrap around the object with a first portion of flexible gripping surface 102 overlapping a second portion of flexible gripping surface. More specifically, flexible gripping surface 102 is configured so that first edge 104 and third edge 108 overlap when the gripping surface is wrapped around the object to be gripped. A first fastening element 120 is secured to outer surface 114 along third edge 108, and a second fastening element 122 is secured to inner surface 118 along first edge 104.

In an exemplary embodiment as shown in FIGS. 1 and 2, first fastening element 120 is a first portion of hook and loop fastening material, for example the loop portion, and second fastening element 122 is the complementary, i.e. hook, portion of hook and loop fastening material, of commercial or industrial grade.

In the exemplary embodiment, the respective portions of hook and loop fastening material are strips of the hook and loop material having a length, and having a width approximating the extent of overlap of edges 104 and 108 when flexible gripping surface 102 is wrapped around the object to be gripped. The strip of first fastening element 120 is aligned along its length with third edge 108, and the strip of second fastening element 122 is aligned its length with first edge 104. First fastening element 120 and second fastening element 122 are thus configured to secure the hand grip closed when the hand grip is wrapped around the object to be gripped. A fabric binding 124 binds the edges of cover layer 112 and base layer 116 together.

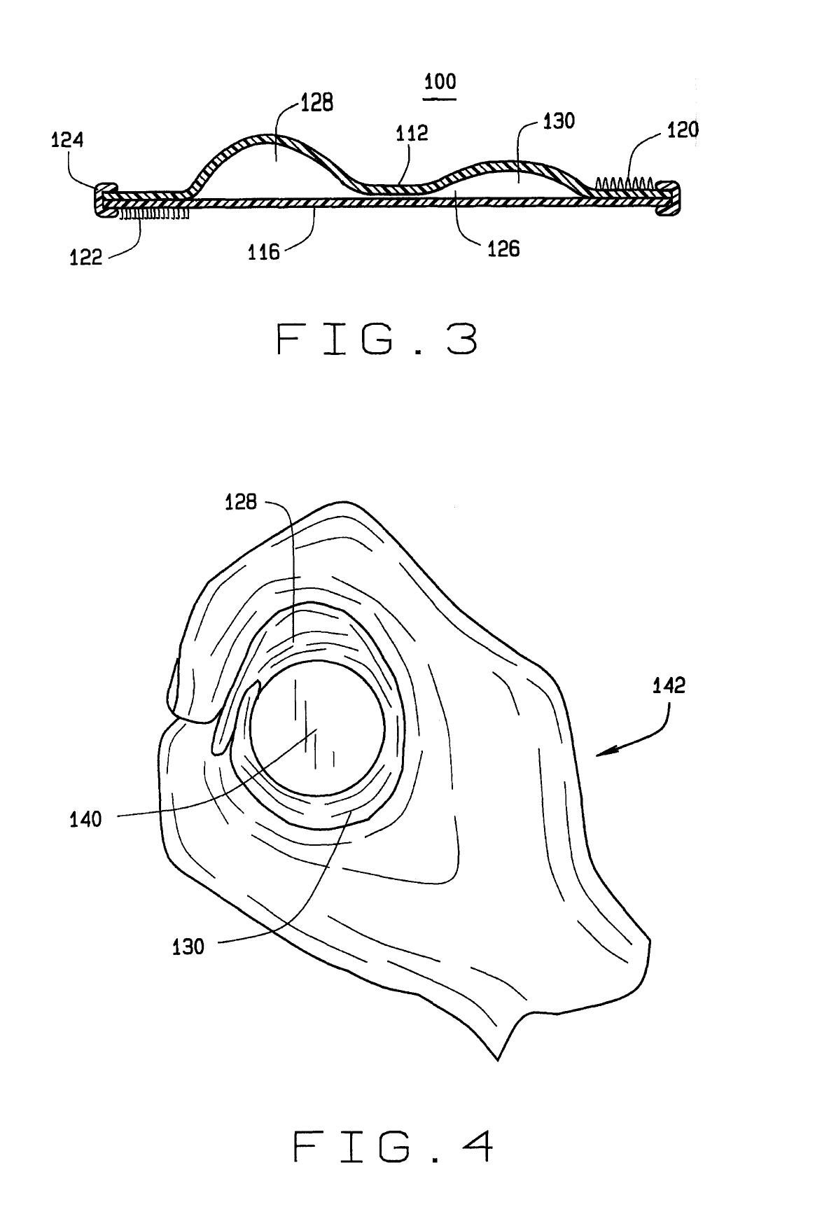

FIG. 3 is a side cross-sectional view of hand grip 100. Multilayered flexible gripping surface 102 includes base layer 116 fabricated from a stretch material that allows the flexible gripping surface to accommodate variations in size of the object to be gripped, and also provides a non-slip surface to prevent the flexible gripping surface from slipping on the object to be gripped when the flexible gripping surface is disposed in place on the object. Suitable materials for the base layer include any rubberized material, including open- or closed-cell rubber, neoprene, a stretch fabric that is impregnated with a rubberized material, or the like.

Cover layer 112 is fabricated from an elastomeric material, for example a stretch fabric. Suitable stretch fabrics include, for example, spandex-containing fabrics, such as fabrics including nylon and spandex, and fabrics including Lycra® brand spandex. In one embodiment the cover layer is fabricated from a nylon/spandex/polyester blend fabric. In an exemplary embodiment the cover layer is fabricated from a “bonded Lycra” material, i.e. a material wherein a fabric or flocking is “bonded” to the back of the Lycra. Interposed between cover layer 112 and base layer 116 is a gel layer 126 of resiliently compressible gel material. In one embodiment, gel layer 126 varies in thickness across its surface such that gel layer provides at least one swell projecting from base layer 116. In an alternative embodiment (not shown), gel layer 126 has a generally uniform thickness.

In an exemplary embodiment, as shown in FIG. 3, gel material 126 is suitably molded to provide a first, or finger swell 128 and a second, or palm swell 130. Swells 128 and 130 are generally oblong or oval in shape, each having a long axis, the swells positioned such that their long axes run approximately parallel to first edge 104 and third edge 108. Swell 128 and swell 130 are sufficiently spaced from one another so that finger swell 128 can be positioned beneath the fingers of a gripping hand while palm swell 130 can be positioned beneath the palm of the gripping hand, when the hand grip 100 is wrapped around the object to be gripped. In an exemplary embodiment, finger swell 128 is slightly higher than palm swell 130 to provide greater cushioning beneath gripping fingers, but swells 128 and 130 can also be of approximately the same height relative to one another.

Gel material layer 126 is fabricated from a urethane gel material, silicone gel or other resiliently compressible gel material. In an exemplary embodiment, the gel material is a polyurethane “capped” co-polymer gel. Other types of co-polymer gels, such as tri-block co-polymer gels can also be used. However, tri-block co-polymer gels and other gel materials that include oil have a tendency to wick oil from the gel at temperatures above about 68-72° F., which can change the durometer of the gel material. In use, hand grip 100 is likely to be routinely exposed to extremes of environmental temperature ranging from extreme subzero temperatures sometimes observed in climates typically inhabited by humans, to temperatures typically observed within closed vehicles exposed to the sun, or in other words, temperatures ranging from about −40° F. to about 150° F. Therefore, especially suitable gel materials include any gel materials, such as “capped” co-polymer gels, that are capable of withstanding exposure to extremes of temperature without degrading. Such gels are especially suitable because they avoid changes in the durometer of the gel material that would be sufficient to render the gel material noticeably less compressible to a person gripping the hand grip. For example, in the exemplary embodiment using a polyurethane “capped” co-polymer gel, the gel material has been found to withstand cold exposure down to at least 0° F., and heat exposure up to 212° F. without any noticeable change in compressibility of the gel material. However, any compressible gel material can be used.

To fabricate hand grip 100, suitably dimensioned and size-matched portions of elastomeric material for cover layer 112, and of neoprene or other suitable material for base layer 116, are prepared from the respective materials. Gel layer 126 is prepared from gel material suitably molded to form finger swell 128 and palm swell 130, and is interposed, as shown in FIG. 3, between cover layer 112 and base layer 116. Layers 112 and 116 are secured or temporarily fixed in position with respect to one another, for example by pinning, tacking, sewing, gluing or otherwise adhering. A strip of loop-type fastening material for first fastening element 120 is prepared and secured to outer surface 114 provided by cover layer 112 along third edge 108, for example by sewing, sonic welding, or adhesive attachment. A strip of hook-type fastening material for second fastening element 122 is prepared and secured to inner surface 118 provided by base layer 116, for example by sewing, sonic welding, or adhesive attachment. Alternatively, the strip of fastening material for second fastening element 122 can be molded into the rubberized material comprising base layer 116. A strip of fabric for binding 124 is prepared and applied to the edges of cover layer 112 and base layer 116, and secured, for example by sewing or adhesive attachment.

FIG. 4 shows a perspective view of hand grip 100 disposed on an object 140 to be gripped, showing also a perspective view of a gripping hand 142. In use, hand grip 100 is wrapped around object 140, with first edge 104 overlapping third edge 108, and is secured in place on object 140 by the cooperative engagement of first fastening element 120, for example loops, with second fastening element 122, for example hooks. Hand grip 100 is appropriately positioned on object 140 so that the fingers of gripping hand 142 are cushioned by finger swell 128 while the palm of gripping hand 142 is cushioned by palm swell 130.

Hand grip 100 can be placed anywhere on an object to be gripped that a user desires, limited only by the requirement that hand grip 100 is suitably placed to be capable of wrapping around the object at the desired position. For example, FIG. 5 shows a perspective view of a steering wheel 144 with a pair of hand grips 100 disposed thereon. For use on a typical automobile steering wheel, for example, a pair of hand grips 100 are used, with either placed at any position on the steering wheel that the user defines, insofar as the placement does not interfere with a spoked area of the wheel. For example one grip is placed at each of the “10 o'clock” and “2 o'clock” positions, or at the “9 o'clock” and “3 o'clock” positions on the wheel

The high degree of flexibility and resiliency of hand grip 100 renders it especially adaptable for use with a wide range of objects other than steering wheels that are also gripped, such as handlebars, levers or any other such gripping object commonly encountered on vehicles, devices, tools or equipment. Variations in application require only that flexible gripping surface 102 be suitably dimensioned to wrap around the object to be gripped, including an area of overlap of first edge 104 with third edge 108 that is sufficient to allow fastening elements to mate, thereby securing flexible gripping surface 102 in place.

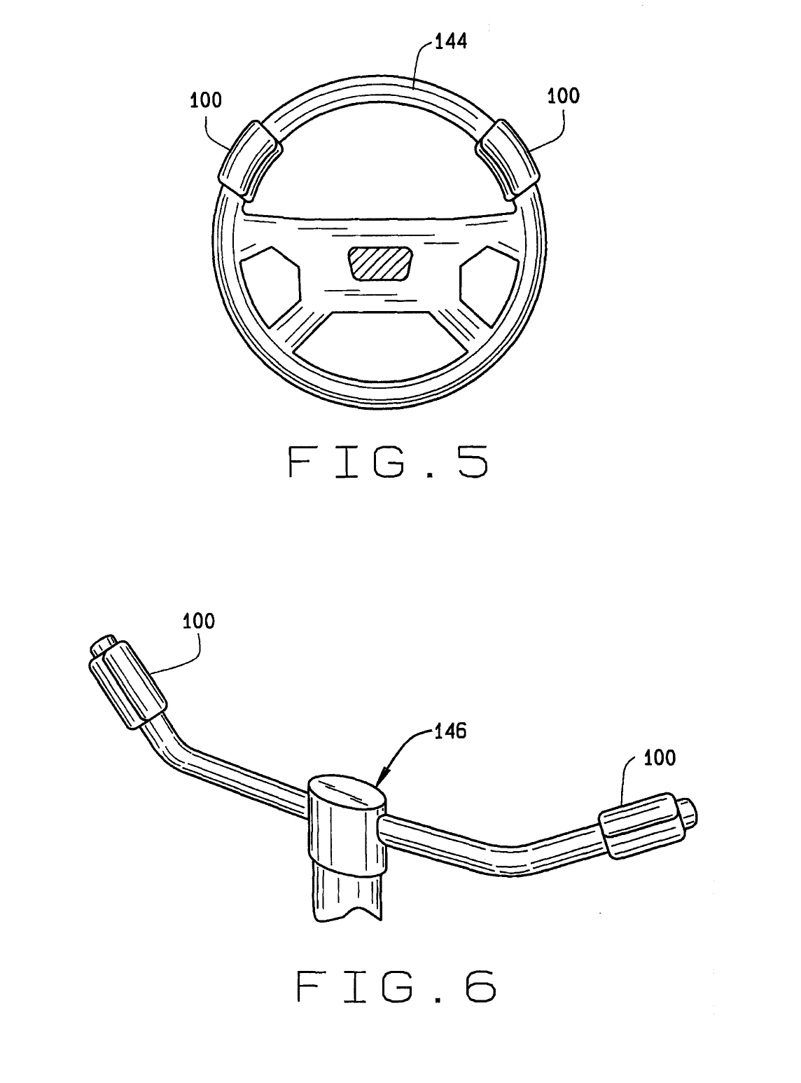

For example, FIG. 6 is a perspective view of a bicycle handle bar 146 with a pair of hand grips 100 disposed thereon. Other applications contemplated for hand grips 100 include, but are not limited to, aircraft steering wheels, joysticks or the like; watercraft steering wheels or elements including tillers, canoe or kayak paddles, oars; the handlebars of motorcycles, scooters, personal watercraft, mopeds, snowmobiles and the like; steering bars on gliders and hang gliders; the handhold areas of sporting goods and exercise equipment including any sort of racquet, stationary bicycles and parabolic machines, treadmills, stair climbing machines, stationary weightlifting machines, free weights, jump rope handles, ski poles; levers, bars or handles of industrial machinery, the handhold areas of rehabilitative, therapeutic and health care equipment such as crutches, walkers, canes, traction bars, and any specialized rehabilitative devices having handhold areas or grips. The resilient gel material of gel layer 126 provides resistance against the squeeze of a gripping hand, thus allowing the user to repeatedly squeeze and release hand grip 100 to exercise as desired the muscles and joints involved in gripping and maintaining grip, including those of the fingers, wrist, hand, arms shoulders and neck. In addition, the exercise itself, as well as the relative increase in diameter of the gripped object, provide stress relief for fingers, hands and arms. Resilient gel layer 126 further provides shock absorbency for shocks and vibrations that may be transmitted through a gripped object to the user. For example, equipment vibrations, or vibrations due to surface variability on roads, trails or water are damped by gel layer 126.

Certain refinements of hand grip 100 are contemplated. In one embodiment, as shown in FIG. 1, a V-shaped notch 148 is cut at about the mid-point along third edge 108, through cover layer 112, base layer 116, and if necessary the loop material of fastening element 120, to relieve puckering of hand grip materials after affixed to a curved device such as a steering wheel. Alternatively, or in addition, a V-shaped notch is cut as needed at about the mid-point along first edge 104, through cover layer 112, base layer 116, and if necessary the hook material of fastening element 122. Hand grip outer surface 114 provides a surface suitable for silk-screen imprinting of customized messages, advertising logos, sports teams logos, contact information and the like. To the extent that an area on outer surface 114 is targeted for printing but is curved because of swells 128 and 130, pad printing can be used to imprint the curved surface. Finished hand grips are sufficiently light in weight and small in size to be especially suitable for packaging in blister-type packaging. In addition, the hand grips are easily opened and spread flat for space-saving storage, display or packaging.

It will be understood that various configurations of hook and loop type fastening material, as well as various types of fastening material or elements are suitable as alternatives for fastening overlapping edges 104 and third edge 108 to one another. For example, each portion of hook and loop type fastening material can be instead two or more sections of material. Alternative fastening elements include, for example, plastic or metal snaps.

It will be appreciated by those skilled in the art that various changes and modifications can be made in the illustrated hand grip apparatus without departing from the scope of the invention. Therefore, the foregoing description and accompanying figures are intended to be illustrative only and should not be construed in a limiting sense.

26. Hand grip apparatus comprising a multi-layered flexible gripping surface having first and second opposed edges, the hand grip apparatus being sufficiently dimensioned to wrap around an object to be gripped; said multi-layered flexible gripping surface comprising:
a cover layer, a base layer and a resiliently compressible gel layer interposed between said cover layer and said base layer; said gel layer comprising a finger swell and a palm swell extending parallel to said opposed first and second edges; said finger and palm swells forming areas of increased thickness of said grip when said grip is wrapped about said object; said finger swell and said palm swell being sufficiently spaced from one another so that said finger swell provides resilient cushioning beneath the fingers of a gripping hand that grips said flexible gripping surface disposed on the object, while said palm swell provides resilient cushioning beneath the palm of the gripping hand;
fastening elements near said first and second edges of said hand grip apparatus; said fastening elements near said first and second edges cooperating with each other to secure said hand grip apparatus about said object; whereby, with said finger and palm swells running generally parallel to said first and second edges, and said fastening elements being near said first and when said hand grip apparatus is wrapped about said object, said finger and palm swells are generally parallel to an axis of said object.

27. Hand grip apparatus in accordance with claim 26 wherein said cover layer comprises an elastomeric material.

28. Hand grip apparatus in accordance with claim 26 wherein said cover layer comprises a stretch fabric.

29. Hand grip apparatus in accordance with claim 26 wherein said base layer comprises a rubberized material.

30. Hand grip apparatus in accordance with claim 26 wherein said base layer comprises neoprene.

31. Hand grip apparatus in accordance with claim 26 wherein said resiliently compressible gel layer comprises a co-polymer gel.

32. Hand grip apparatus in accordance with claim 26 wherein said resiliently compressible gel layer comprises a polyurethane gel.

33. Hand grip apparatus in accordance with claim 32 wherein said resiliently compressible gel layer comprises a capped co-polymer gel.

34. Hand grip apparatus in accordance with claim 26 wherein said first fastening element comprises a loop portion of hook and loop fastening material and said second fastening element comprises a hook portion of hook and loop fastening material.

35. Hand grip apparatus in accordance with claim 26 including a notch cut in one of said first and second edges of said hand grip apparatus.

36. Grip apparatus comprising:
a multi-layered flexible gripping surface dimensioned to wrap around a curved object and having first and second opposed edges, said first edge overlapping said second edge of said flexible gripping surface when said flexible gripping surface is wrapped around the object;
a first fastening element adjacent said gripping surface first edge;
a second fastening element adjacent said gripping surface second edge and configured to cooperate with said first fastening element when said gripping surface first portion and said gripping surface second portion overlap; and
a notch extending through at least one of said first and second edges to relieve puckering of said gripping surface when wrapped about said curved object.

37. Grip apparatus in accordance with claim 36 wherein said multi-layered flexible gripping surface comprises a cover layer, a base layer and a gel layer interposed between said cover layer and said base layer.

38. Grip apparatus in accordance with claim 37 wherein said cover layer comprises an elastomeric material, and said base layer comprises a rubberized material.

39. Grip apparatus in accordance with claim 37 wherein said base layer comprises neoprene.

40. Grip apparatus in accordance with claim 37 wherein said first fastening element and said second fastening element comprise hook and loop fastening material.

41. Grip apparatus in accordance with claim 37 wherein said first fastening element comprises a strip of loop material secured to said cover layer along said gripping surface first edge, and said second fastening element comprises a strip of hook material secured to said base layer along said gripping surface second edge.

42. Grip apparatus in accordance with claim 37 wherein said gel layer comprises a gel material molded to provide at least a first cushioning swell projecting from said base layer, said cushioning swell defining an area of increased thickness when said grip is wrapped about the object.

43. Grip apparatus in accordance with claim 42 wherein said cushioning swell extends generally parallel to said first and second edges to be generally parallel to an axis of said object when said grip is wrapped about said object.

44. Grip apparatus in accordance with claim 42 wherein said gel material comprises a co-polymer gel.

45. Grip apparatus in accordance with claim 42 wherein said gel material comprises a capped co-polymer gel.

46. Grip apparatus in accordance with claim 42 wherein said gel layer comprises a gel material molded to provide a finger swell and a palm swell projecting from said base layer.
